(19) United States
(12) Patent Application Publication
(10) Pub. No.: US 2013/0159065 A1
(43) Pub. Date: Jun. 20, 2013

(54) BEHAVIOR-BASED PRICING PARADIGM

(71) Applicants: Christopher FAWCETT, San Diego, CA (US); Michael Anthony FASULO, Carlsbad, CA (US); Neal MANOWITZ, San Diego, CA (US); Jerry PYMM, Sandy, UT (US); Stephen TATE, Escondido, CA (US); Kristy Royall RENNIE, San Diego, CA (US); Heng-I Randall LU, Carlsbad, CA (US); Tania J. HURT, San Diego, CA (US); Sheri G. ESPINOZA-BROXSON, San Diego, CA (US); Endrew Monroe BUBALA, Tokyo (JP); David W. FISHER, Carlsbad, CA (US)

(72) Inventors: Christopher FAWCETT, San Diego, CA (US); Michael Anthony FASULO, Carlsbad, CA (US); Neal MANOWITZ, San Diego, CA (US); Jerry PYMM, Sandy, UT (US); Stephen TATE, Escondido, CA (US); Kristy Royall RENNIE, San Diego, CA (US); Heng-I Randall LU, Carlsbad, CA (US); Tania J. HURT, San Diego, CA (US); Sheri G. ESPINOZA-BROXSON, San Diego, CA (US); Endrew Monroe BUBALA, Tokyo (JP); David W. FISHER, Carlsbad, CA (US)

(73) Assignee: SONY CORPORATION

(21) Appl. No.: 13/532,566

(22) Filed: Jun. 25, 2012

Related U.S. Application Data
(60) Provisional application No. 61/578,100, filed on Dec. 20, 2011.

(51) Int. Cl. G06Q 10/06; G06Q 30/02

(52) U.S. Cl. 705/7.36

(57) ABSTRACT

A computer includes a processor and a computer readable storage medium accessible to the processor and bearing instructions executable by the processor to cause the processor to determine whether to apply a basic discount to an account of a seller of products based at least in part on determining whether the seller has adhered to a seller agreement. The instructions also cause the processor to determine whether to apply an efficiency discount to the account based at least in part on determining whether at least one efficiency metric has been satisfied, determine whether to apply a strategy discount to the account based at least in part on whether at least one strategy metric has been satisfied, and determine whether to apply an execution discount to the account based at least in part on whether at least one execution metric has been satisfied.

### RELATED APPLICATIONS

Priority is claimed from U.S. provisional application 61/578,100, filed Dec. 20, 2011, incorporated herein by reference.

### I. FIELD OF THE INVENTION

The present application relates generally to behavior-based pricing paradigms.

### II. BACKGROUND OF THE INVENTION

The impact of volatile market conditions and shrinking profit margins in the consumer electronics industry require intelligent cooperation and incentivization between product manufacturer and product seller/vendors, including retailers, distributors, etc. Present principles understand that a comprehensive program is required to update decades-old sales and marketing guidelines and the rules that govern business dealings between product manufacturers and their seller/vendors.

### SUMMARY OF THE INVENTION

Accordingly, present principles address the challenge of creating an innovative reward-to-value relationship between a product manufacturer and its seller/vendors. Present principles incorporate a unique array of discounts and allowances alongside compliance checks and a computerized tracking tool to allow dealers, distributors, and the manufacturer alike to earn profits based on clear, common behavioral characteristics vs. the vague, variable negotiation-based pricing models of the past.

In one aspect, a computer includes a processor and computer readable storage medium accessible to the processor. The medium bears instructions executable by the processor to cause the processor to determine whether to apply a basic discount to an account of a seller of products based at least in part on determining whether the seller has adhered to a seller agreement. The instructions also cause the processor to determine whether to apply an efficiency discount to the account of the seller based at least in part on determining whether at least one efficiency metric has been satisfied by the seller. The efficiency discount is understood to be established by one or more of a payment efficiency discount with an efficiency metric of payment with a predetermined time period and/or payment by a predetermined payment mode, as well as a return efficiency discount with an efficiency metric of adherence to a manufacturer's return policy.

Furthermore, the instructions cause the processor to determine whether to apply a strategy discount to the account of the seller based at least in part on whether at least one strategy metric has been satisfied by the seller. The strategy discount is established by one or more of a collaborative planning discount with a strategy metric of providing at least one sales forecast, a point of sale (POS) sell-out discount with a strategy metric of compliant sales, an assortment strategy discount with a strategy metric of achieving a predetermined product assortment, a premium product strategy discount with a strategy metric of sales of premium products, and an allowance strategy discount with a strategy metric of complying with at least one advertising standard for a predetermined product.

Additionally, the instructions cause the processor to determine whether to apply an execution discount to the account of the seller based at least in part on whether at least one execution metric has been satisfied by the seller. The execution discount is established by one or more of a consumer visibility execution discount with an execution metric of adhering to a predetermined product merchandising and display plan, a consumer conversion execution discount with an execution metric of shopper questionnaire approval, and an advertising fund execution discount with an execution metric of advertising by the seller.

In some embodiments, the efficiency discount may be established by the payment efficiency discount with the efficiency metric of payment with a predetermined time period, by the payment efficiency discount with the efficiency metric of payment with and/or payment by a predetermined payment mode, and/or by the return efficiency discount with the efficiency metric of adherence to a manufacturer's return policy. Also in some embodiments, the strategy discount may be established by the collaborative planning discount with the strategy metric of providing at least one sales forecast, by the point of sale (POS) sell-out discount with the strategy metric of compliant sales, by the assortment strategy discount with the strategy metric of achieving a predetermined product assortment, by the premium product strategy discount with the strategy metric of sales of premium products, and/or by the allowance strategy discount with the strategy metric of complying with at least one advertising standard for a predetermined product. Even further, if desired the execution discount may be established by the consumer visibility execution discount with the execution metric of adhering to a predetermined product merchandising and display plan, by the consumer conversion execution discount with the execution metric of shopper questionnaire approval, and/or by the advertising fund execution discount with the execution metric of advertising by the seller.

In another aspect, a computer includes a processor and a computer readable storage medium accessible to the processor. The medium bears instructions executable by the processor to cause the processor to store seller discounts that are based on desired seller behavior, receive information relating to seller behavior, and then use the information to ascertain whether predetermined discount metrics have been satisfied.

In still another aspect, a computer includes a processor and a computer readable storage medium accessible to the processor. The medium bears instructions executable by the processor to cause the processor to determine whether to apply a basic discount to an account of a seller of products based at least in part on determining whether the seller has adhered to a seller agreement.

In yet another aspect, a computer includes a processor and a computer readable storage medium accessible to the processor. The computer is a first computer in communication over a network under control of the processor of the first computer with a second computer. The second computer also includes a processor and computer readable storage medium accessible to the second computer's processor. It is to be understood that the first computer is associated with a manufacturer providing products to be vended to a vendor and that the second computer is associated with the vendor. The first computer receives information from the second computer over the network regarding the vendor's performance of vending the manufacturer's products. The processor of the first computer then analyzes the performance using one or more predetermined performance metrics to determine whether one or more incentivizing discounts should be provided to the vendor by the manufacturer.

The details of the present invention, both as to its structure and operation, can be best understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of overall logic;

FIG. 3 is a flow chart of example basic discount logic;

FIG. 4 is a flow chart of example efficiency discount logic;

FIG. 5 is a flow chart of example efficiency discount logic;

FIG. 6 is a flow chart of example strategy discount logic;

FIG. 7 is a flow chart of example strategy discount logic;

FIG. 8 is a flow chart of example strategy discount logic;

FIG. 9 is a flow chart of example strategy discount logic;

FIG. 10 is a flow chart of example strategy discount logic;

FIG. 11 is a flow chart of example execution discount logic;

FIG. 12 is a flow chart of example execution discount logic;

FIG. 13 is a flow chart of example execution discount logic; and

FIG. 14 is a flow chart of example promotional logic.

### DETAILED DESCRIPTION OF THE PREFERRED EMBODIMENT

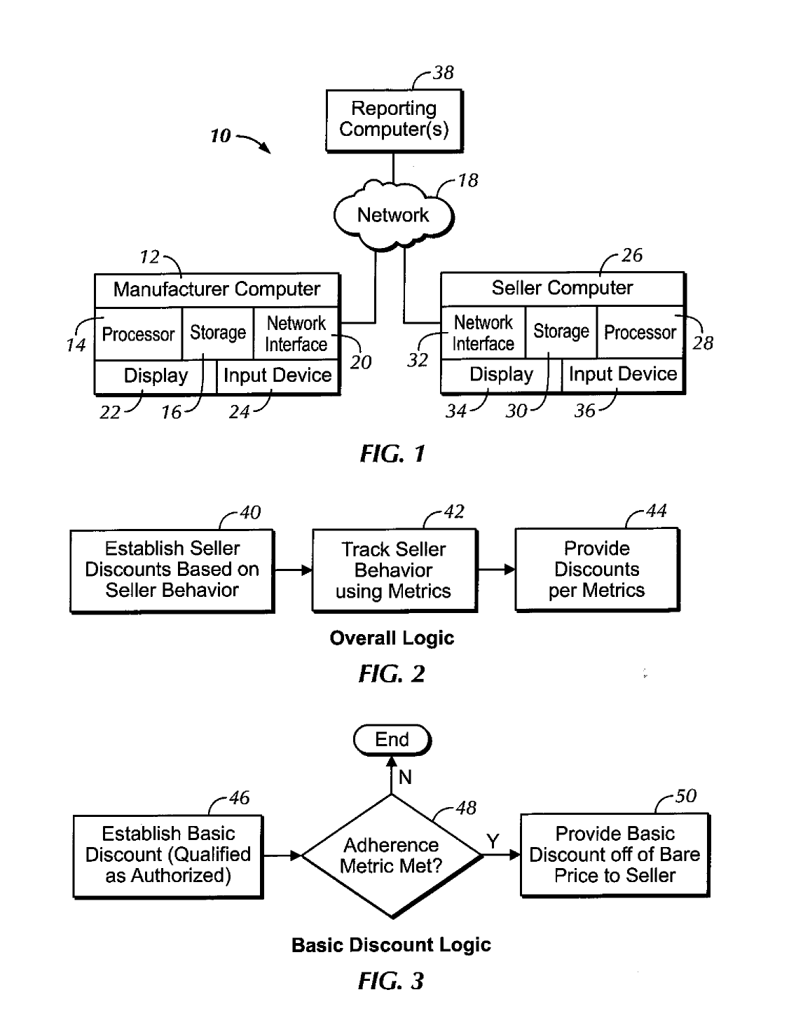

Referring initially to the non-limiting example embodiment shown in FIG. 1, a system 10 includes one or more manufacturer computers 12 each with one or more processors 14 accessing one or more tangible computer readable storage media 16 such as disk-based or solid state storage. It is to be understood that the processors described herein, such as the processors 14, execute the logic described below in accordance with present principles. Regardless, note that the computer 12 can communicate with a network 18 such as the Internet using a network interface 20 such as a wired or wireless modem or router or other appropriate interface, e.g., a wireless telephony transceiver. The computer 12 can receive video from multiple sources including the Internet and video can be presented under control of the processor 14 on a display 22 such as but not limited to a high definition flat panel display, and may be a touch screen display. User commands to the processor 14 may be received from one or more input devices 24 such as mice, keyboards, keypads, etc. The manufacturer computer 12 is affiliated with a manufacturer of products who wishes to employ present incentivization principles with its product sellers, e.g., retailers, distributors, and the like.

Accordingly, one or more seller computers 26 communicate with the manufacturer computer 12 over, e.g., the network 18. The seller computer 26 has one or more processors 28 accessing one or more tangible computer readable storage media 30 such as disk-based or solid state storage. The computer 26 can communicate with the network 18 using a network interface 32 such as a wired or wireless modem or router or other appropriate interface, e.g., a wireless telephony transceiver. The computer 26 can receive video from multiple sources including the Internet and video can be presented under control of the processor 28 on a display 34 such as but not limited to a high definition flat panel display, and may be a touch screen display. User commands to the processor 28 may be received from one or more input devices 36 such as mice, keyboards, keypads, etc.

Additionally, one or more reporting computers 38 may communicate with the manufacturer computer 12. The reporting computer 38 may be operated by the manufacturer, the seller, or by a third party to render various reports of incentive metrics discussed further below. The reporting computer 38 includes similar components as the other two computers 12, 26 shown in FIG. 1.

According to present principles, the manufacturer computer 12 makes various determinations regarding discounts to be granted to the seller affiliated with the seller computer 26 based on metrics agreed to in advance by manufacturer and seller. The metrics are tracked by tracking software which envisions varying degrees of manual input and which provides the tracked information to the manufacturer computer 12. In some implementations personnel at the seller premises enter the requisite information into computer forms, which are then transmitted from the seller computer 26 to the manufacturer computer 12. Information in metrics may also be entered directly into the manufacturer computer 12 by manufacturer personnel or independent third parties monitoring activity at the seller premises and entering data accordingly into the reporting computer 38, which sends the information to the manufacturer computer 12. Still further, for some metrics, e.g., whether a particular device type is displayed in a store in a particular location, pressure or contact sensors on store shelves may use, e.g., radiofrequency identification (RFID), Bluetooth, or other short range communication system to sense the identification, including serial number and model number, of products that are on or near the sensors. The sensors, whose locations are known either from GPS information received from the sensors or from pre-recorded shelf position information, report the product IDs over the network to the manufacturer computer 12, which then uses the sensor reports to track certain metrics. Other tracking methods may be used.

In any case, with the above in mind, the table below illustrates example discounts with their definitions and metrics (“measurements”) according to present principles, while FIGS. 3-14 illustrate example logic according to the table.

Accordingly, present principles address the challenge of creating an innovative reward-to-value relationship between a product manufacturer and its seller/vendors. Present principles incorporate a unique array of discounts and allowances alongside compliance checks and a computerized tracking tool to allow dealers, distributors, and the manufacturer alike to earn profits based on clear, common behavioral characteristics vs. the vague, variable negotiation-based pricing models of the past.

| | | Definition | Measurement |
|---|---|---|---|
| Basic Discount | | | |
| Base Margin | DFI | earned for qualifying as a Sony Reseller | Adherence to Sony Reseller Agreement |
| | | Network authorized dealer | |
| Efficiency Discounts | | | |
| Payment Efficiency | DFI | earned for paying quickly and through | Payment within 15 days via electronic format and |
| | | electronic means | electronic remittance |
| Returns | DFI* | earned for managing returned products and | Adherence to Sony's Return Policy for specific |
| | | adhering to SEL's policy | product categories |
| Strategy Discounts | | | |
| Collaborative | DFI | earned for collaborating with SEL on sales | Provide Sell In Forecast (20% of Total Award) |
| Business Planning | | strategy, forecasting, promotional | Provide Sell Through Forecast (80% of Total Award) |
| | | activities and measurement | |
| POS Sell-out Data | DFI | earned for providing EDI 852 “product | By SKU: 25% of total available discount |
| | | activity” compliant sales data | By Store (Total Online/B&M): 50% of total |
| | | | available discount |
| | | | Online vs. Store (B&M) Breakout: 100% of total |
| | | | available discount |
| Assortment | DFI | earned for assorting a range of Sony | Prescribed SKU list vs. Actual PO placed (%) |
| | | products within a business segment | |
| Premium Product | DFI | earned for assorting and selling Sony's | Agreed upon SKU list versus actual P.O. placed (%) |
| Focus | | step-up products; the primary way for a | |
| | | dealer to dramatically increase profit | |
| MAP Allowance | DFI | earned by advertising specific products | Compliance with the MAP Program |
| | | according to the terms of SEL's MAP policy | |
| Execution Discounts | | | |
| Consumer Visibility | TC | earned for merchandising and displaying | Adherence to agreed upon merchandising plan |
| | | Sony products and displays in a timely | 85% to 100% compliance - 100% payout |
| | | and functioning manner, improving sell | 51% to 84% compliance - 50% payout |
| | | through for Sony and the Dealer | 0 to 50% compliance - 0% payment |
| Consumer | TC | earned for knowledgeable and professional | Mystery Shopper Questionnaire |
| Conversion | | sales staff that advocates Sony products | 85% to 100% compliance - 100% payout |
| | | | 51% to 84% compliance - 50% payout |
| | | | 0 to 50% compliance - 0% payment |
| Advertising Fund | TC | earned for advertising specific Sony | Sony will reward the dealer with a dollar for |
| | | products | dollar matching credit as a set percentage of |
| | | | dollar volume ordered from Sony beginning |
| | | | April 1 of each year |
| Promotions | | | |

| | | |
|---|---|---|
| Profit Enhancers | TC | SPIFF, 0% Financing, Display Allowance, Cooperative Advertising, Brand Advocates (SGA), In |
| Sales Drivers | TC | home Installation, Bundles, Instant Rebates, Price Protection |
| Price Response | TC | |

However, turning first to FIG. 2 for an understanding of general logic principles, commencing at block 40 seller discounts are established, typically by the manufacturer, based on desired seller behavior. Moving to block 42 seller behavior is tracked to ascertain whether certain predetermined discount metrics have been satisfied, and at block 44 discounts are provided (or not) based on the metrics.

Now addressing FIG. 3, a flow chart of example basic discount logic is shown. Thus, FIG. 3 shows the logic for a computerized tracking tool and/or, e.g., a manufacturer computer such as the manufacturer computer 12 to determine whether to apply a basic discount to an account of a seller of products based at least in part on determining whether the seller has adhered to a seller agreement. Beginning with block 46, a basic discount is established by the logic based on, e.g., a predetermined agreement between a manufacturer and retail seller/vendor in accordance with present principles.

Moving to decision diamond 48, the logic determines whether a seller's adherence to the metric related to the basic discount has been met and/or satisfied. If it has not, the logic ends. However, if the logic determines that the metric has been met, the logic proceeds to block 50 where a basic discount off of the base price of a good from the manufacturer to the seller is provided and/or applied to the seller's account.

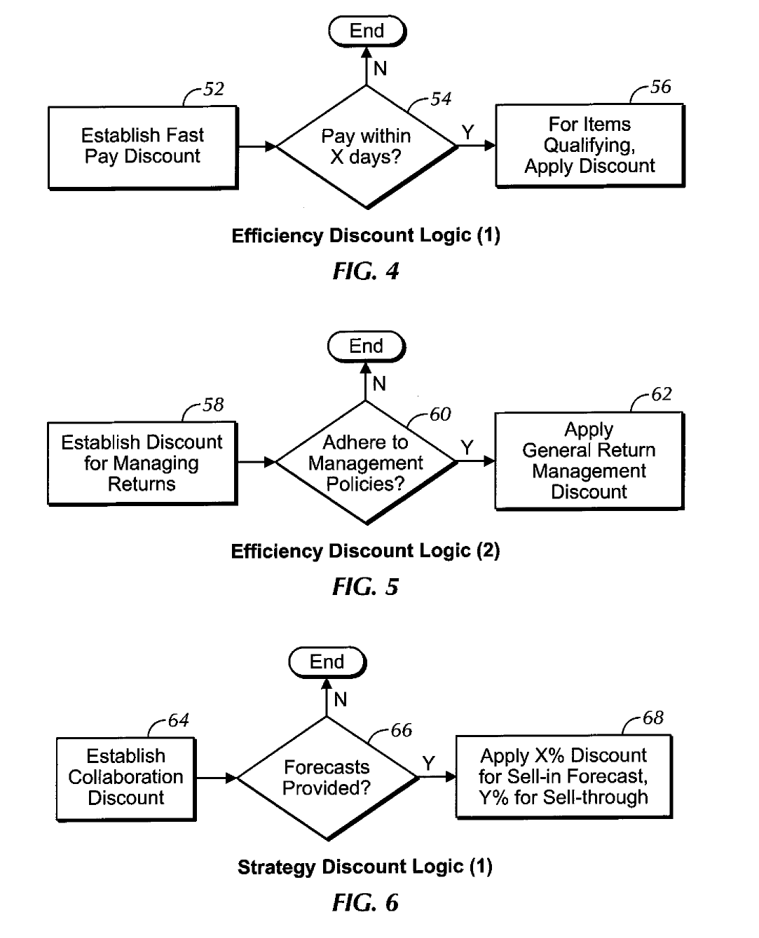

Turning now to FIG. 4, a flow chart of example efficiency discount logic is shown. Thus, FIG. 4 shows the logic for a computerized tracking tool and/or, e.g., a manufacturer computer such as the manufacturer computer 12 to determine whether to apply a payment efficiency discount to the account of the seller based at least in part on determining whether at least one efficiency metric has been satisfied by a seller of goods. Thus, beginning with block 52, the logic establishes a fast-pay/payment efficiency discount based on, e.g., a predetermined agreement between a manufacturer and retail seller/vendor in accordance with present principles. Then at decision diamond 54 the logic determines whether a payment has been provided by the seller to the manufacturer within “X” days, it being understood that “X” days may be a range of days in which a particular payment is to be provided, a maximum number of days after a fiscal interval in which payment is to be provided, a predetermined time period for which payment is to be provided, and/or payment with/by a predetermined payment mode such as, but not limited to, direct deposit, direct delivery to the manufacturer, payment by mail, etc. If the logic determines that payment has not been provided within “X” days, the logic ends. If, however, the logic determines that this metric has been met, the logic moves to block 56 where the logic applies the efficiency discount for items that qualify for the discount to the seller's account.

Addressing FIG. 5, another flow chart of example efficiency discount logic is shown. Thus, FIG. 5 shows the logic for a computerized tracking tool and/or, e.g., a manufacturer computer such as the manufacturer computer 12 to determine whether to apply a return efficiency discount to the account of the seller based at least in part on determining whether at least one efficiency metric has been satisfied by a seller of goods. Thus, beginning with block 58, the logic establishes a discount for managing returns based on, e.g., a predetermined agreement between a manufacturer and retail seller/vendor in accordance with present principles where the efficiency metric is related to adherence to a manufacturer's return policy. Moving to decision diamond 60, the logic determines whether a seller has adhered to a manufacturer's return policy. If the seller has not, the logic ends. However, if the logic determines that the seller has adhered to the policy, the logic proceeds to block 62 where a general return management discount is applied to the seller's account.

Turning now to FIG. 6, a flow chart of example strategy discount logic is shown. Thus, FIG. 6 shows the logic for a computerized tracking tool and/or, e.g., a manufacturer computer such as the manufacturer computer 12 to determine whether to apply a strategy discount to the account of the seller based at least in part on determining whether at least one strategy metric has been satisfied by a seller of goods. Thus, beginning with block 64, the logic establishes a collaboration planning discount based on, e.g., a predetermined agreement between a manufacturer and retail seller/vendor in accordance with present principles where the metric is related to providing at least one sales forecast. Moving to decision diamond 66, the logic determines whether a seller/vendor's sales forecasts have been provided to the manufacturer. If they have not, the logic ends. However, if the logic determines that they have been provided, the logic proceeds to block 68 where an “X” percent discount may be applied to the seller's account for a sell-in forecast, and/or a “Y” percent discount may be applied to the seller's account for a sell-through forecast. Note that both the “X” percent and “Y” percent discounts may be predetermined in accordance with present principles.

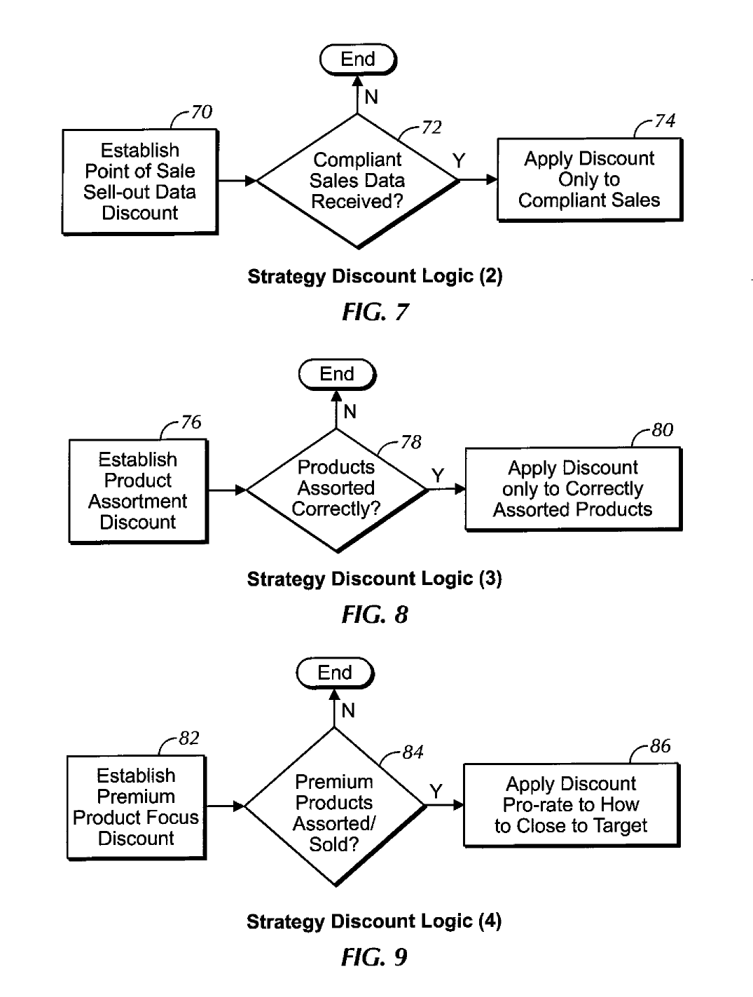

Moving on to FIG. 7, a flow chart of example strategy discount logic is shown. Thus, FIG. 7 shows the logic for a computerized tracking tool and/or, e.g., a manufacturer computer such as the manufacturer computer 12 to determine whether to apply a strategy discount to the account of the seller based at least in part on determining whether at least one strategy metric has been satisfied by a seller of goods. Thus, beginning with block 70, the logic establishes a point of sale (POS) sell-out data discount based on, e.g., a predetermined agreement between a manufacturer and retail seller/vendor in accordance with present principles where the metric is related to compliant sales. Moving to decision diamond 72, the logic determines whether compliant sales data has been received by the manufacturer. If the data has not been received, the logic ends. However, if the logic determines that the data has been received, the logic proceeds to block 74 where a discount is applied only to the compliant sales of a seller's account.

Now addressing FIG. 8, a flow chart of example strategy discount logic is shown. Thus, FIG. 8 shows the logic for a computerized tracking tool and/or, e.g., a manufacturer computer such as the manufacturer computer 12 to determine whether to apply a strategy discount to the account of the seller based at least in part on determining whether at least one strategy metric has been satisfied by a seller of goods. Thus, beginning with block 76, the logic establishes a product assortment discount (and/or in some embodiments an assortment strategy discount) based on, e.g., a predetermined agreement between a manufacturer and retail seller/vendor in accordance with present principles where the metric is related to achieving a predetermined product assortment (and/or in some embodiments implementing a predetermined assortment strategy).

Moving to decision diamond 78, the logic determines whether the seller's products have been assorted correctly, e.g., per the predetermined agreement between the seller and manufacturer. If the products have not been assorted correctly, the logic ends. However, if the logic determines that the products have been assorted correctly, the logic proceeds to block 80 where a discount is applied only to correctly assorted products of the seller's account.

Next, attention is drawn to FIG. 9, which is a flow chart of example strategy discount logic. Thus, FIG. 9 shows the logic for a computerized tracking tool and/or, e.g., a manufacturer computer such as the manufacturer computer 12 to determine whether to apply a strategy discount to the account of the seller based at least in part on determining whether at least one strategy metric has been satisfied by a seller of goods. Thus, beginning with block 82, the logic establishes a premium product focus and/or strategy discount based on, e.g., a predetermined agreement between a manufacturer and retail seller/vendor in accordance with present principles where the metric is related to sales of premium products. Moving to decision diamond 84, the logic determines whether premium products have been assorted, positioned (e.g., on a showroom floor per an agreement between the manufacturer and seller), and/or sold. If they have not, the logic ends. However, if the logic determines that they have, the logic proceeds to block 86 where a discount is applied to the seller's account pro-rata according to how close assortment(s), positioning, and/or sales were to a target and/or goal of assortments, positions, and/or sales. Note that the target may also be predetermined in accordance with present principles.

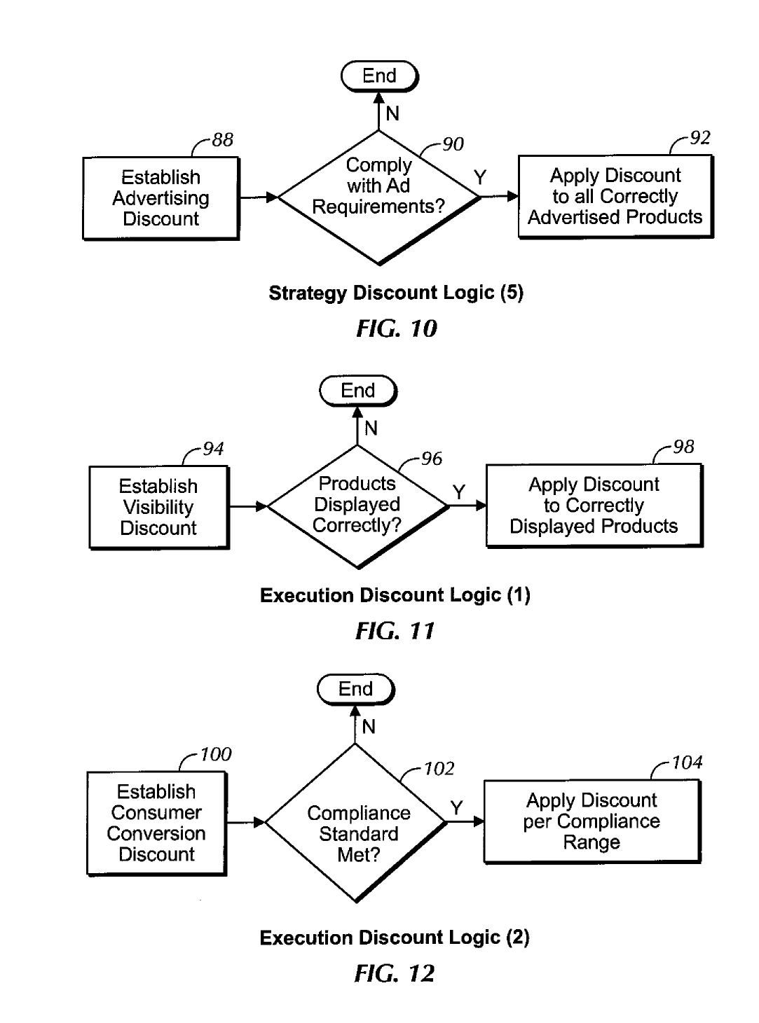

Turning now to FIG. 10, a flow chart of example strategy discount logic is shown. Thus, FIG. 10 shows the logic for a computerized tracking tool and/or, e.g., a manufacturer computer such as the manufacturer computer 12 to determine whether to apply an allowance strategy discount to the account of the seller based at least in part on determining whether at least one strategy metric has been satisfied by a seller of goods. Thus, beginning with block 88, the logic establishes an advertising discount based on, e.g., a predetermined agreement between a manufacturer and retail seller/vendor in accordance with present principles where the metric is related to complying with at least one advertising standard for a predetermined product. Moving to decision diamond 90, the logic determines whether a manufacturer's advertising request(s) has been complied with. If it has not, the logic ends. However, if the logic determines that the manufacturer's advertising request(s) has been complied with, the logic proceeds to block 92 where a discount is applied to the seller's account to all correctly advertised products.

Continuing the detailed description in reference to FIG. 11, a flow chart of example execution discount logic is shown. Thus, FIG. 11 shows the logic for a computerized tracking tool and/or, e.g., a manufacturer computer such as the manufacturer computer 12 to determine whether to apply an consumer visibility execution discount to the account of the seller based at least in part on determining whether at least one execution metric has been satisfied by a seller of goods. Thus, beginning with block 94, the logic establishes a visibility discount based on, e.g., a predetermined agreement between a manufacturer and retail seller/vendor in accordance with present principles where the metric is related to adhering to a predetermined product merchandising and display plan. Moving to decision diamond 96, the logic determines whether the manufacturer's products have been displayed correctly by the seller and/or according to the predetermined product merchandising and display plan. If they have not, the logic ends. However, if the logic determines that the product(s) have been displayed correctly and/or according to the plan, the logic proceeds to block 98 where a discount is applied to the correctly displayed products in the seller's account.

Moving on to FIG. 12, a flow chart of example execution discount logic is shown. Thus, FIG. 12 shows the logic for a computerized tracking tool and/or, e.g., a manufacturer computer such as the manufacturer computer 12 to determine whether to apply an execution discount to the account of the seller based at least in part on determining whether at least one execution metric has been satisfied by a seller of goods. Thus, beginning with block 100, the logic establishes a consumer conversion execution discount based on, e.g., a predetermined agreement between a manufacturer and retail seller/vendor in accordance with present principles where the metric is related to shopper questionnaire approval. Thus, in some embodiments the seller may be required to provide a questionnaire to the seller's customers either in electronic format (e.g., a website, an in-store tablet computer usable by customers to complete the questionnaire, etc.) and/or paper (i.e. hardcopy) format. Moving to decision diamond 102, the logic determines whether the seller has complied with the manufacturer's standard for, e.g., consumer approval derived from the questionnaires and/or percentage of customers to complete the questionnaire. If the standard has not been met, the logic ends. However, if the logic determines that the standard has been met, the logic proceeds to block 104 where a discount is applied to the seller's account according to the range of compliance.

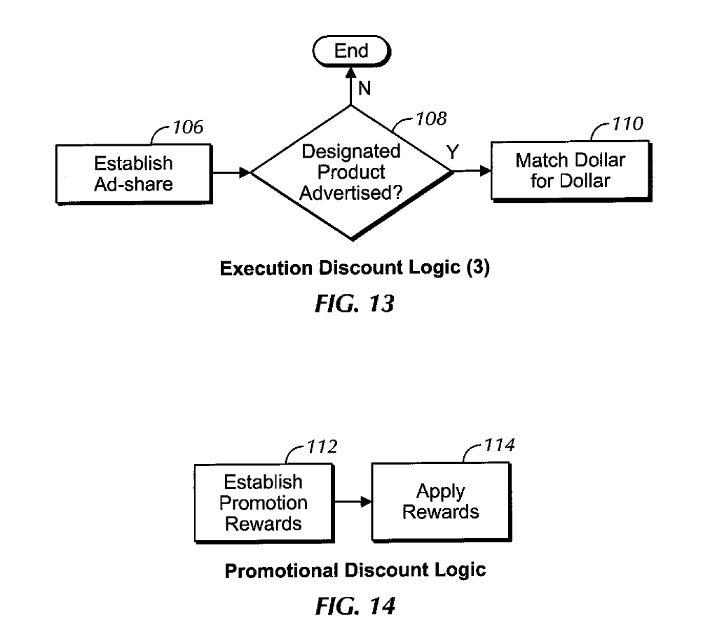

Now addressing FIG. 13, a flow chart of example execution discount logic is shown. Thus, FIG. 13 shows the logic for a computerized tracking tool and/or, e.g., a manufacturer computer such as the manufacturer computer 12 to determine whether to apply an execution discount to the account of the seller based at least in part on determining whether at least one execution metric has been satisfied by a seller of goods. Thus, beginning with block 106, the logic establishes an advertising fund execution discount based on, e.g., a predetermined agreement between a manufacturer and retail seller/vendor in accordance with present principles where the metric is related to advertising by the seller. More specifically, the agreement may be to share advertising costs if the seller advertises per certain terms of the agreement. Accordingly, moving to decision diamond 108, the logic determines whether a designated product (e.g., a product designated by the manufacturer) has been advertised. Furthermore, note that in some implementations, the logic may determine not just whether a designated product has been advertised, but whether it was advertised according to the manufacturer's specifications (e.g., frequency of advertising and/or number of publications in which the advertisement was placed). If it has not, the logic ends. However, if the logic determines that a designated product has been advertised, the logic proceeds to block 110 where the manufacturer matches the seller's advertising costs dollar for dollar. This may be done by depositing funds into the seller's account or adjusting a monetary exchange between the manufacturer and seller to result in a net credit to the seller corresponding to a dollar for dollar matching of advertising revenue.

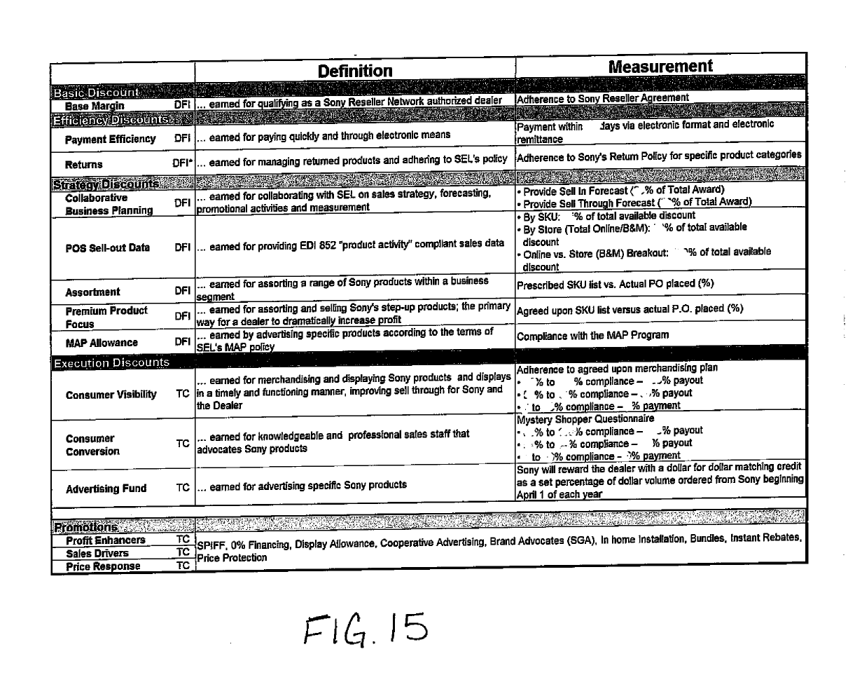

Moving on, reference is now made to FIG. 14, which shows a flow chart of example promotional discount logic. Thus, FIG. 14 shows the logic for a computerized tracking tool and/or, e.g., a manufacturer computer such as the manufacturer computer 12 to determine whether to apply a promotional discount to the account of the seller based at least in part on determining whether at least one promotional metric has been satisfied by a seller of goods. Thus, beginning with block 112, the logic establishes a promotional rewards discount based on, e.g., a predetermined agreement between a manufacturer and retail seller/vendor in accordance with present principles. Then at block 114 the rewards are applied to the seller's account.

In another implementation, a strategic investment computerized tracking tool incorporates the terms and conditions applicable to all consumer products (“Products”) that a seller/vendor purchases from a manufacturer. The manufacturer thus provides the seller/vendor with the opportunity to earn discounts and allowances, provided by way of being deducted from invoice (DFI) or as a trailing credit (TC) on various categories of products, as a percentage from the price the manufacturer announces from time to time in consideration of the seller/vendor's efforts to efficiently transact business with the manufacturer, collaborate with the manufacturer in joint business planning and engage in activities that increase a seller/vendor's purchase and sell through of the manufacturer products and promote the manufacturer brand.

In some embodiments this program is subject to certain terms and conditions such as the ones set forth below and set forth in a seller/vendor Agreement between the manufacturer and the seller/vendor. Furthermore, to the extent that there are any conflicts between the terms and conditions set forth in the seller/vendor agreement and the terms set forth below in accordance with the manufacturer program, the terms and conditionals of the manufacturer program are understood to apply.

Note that each seller/vendor is free to independently determine whether it wishes to participate in the program with the manufacturer in whole or in part, and each program may run for the time period of a year. Sellers/vendors who are eligible are understood to be all sellers/vendors who are authorized to sell the manufacturer's qualifying products, where the qualifying products may be some or all of the products manufactured and/or provided by the manufacturer.

Base Margin: In consideration of seller/vendor meeting certain requirements, the manufacturer may provide to the seller/vendor a category deduct from invoice (DFI) set forth in manufacturer price sheets. The, the seller/vendor should maintain its retail location(s) as required by the seller/vendor agreement. If authorized to transact online, the seller/vendor should maintains its authorized website(s) as required to the “Online Addendum” to the seller/vendor agreement referenced herein. Products carried by the seller/vendor should be properly displayed at all times and the seller/vendor should carry sufficient inventory to meet its consumer demand. Furthermore, the seller/vendor should be in compliance with the terms of the seller/vendor agreement and all manufacturer programs in which it participates.

In consideration of seller/vendor making payment for products in accordance with the terms that the manufacturer announces, from time to time the manufacturer provides to the seller/vendor a discount as set forth in a manufacturer price sheet(s) referenced herein. In some embodiments, this discount is understood to be contingent on the seller/vendor not making any deductions from any payments unless authorized by the manufacturer via an official credit memorandum or as otherwise permitted by the seller/vendor agreement. Any deductions authorized or permitted should be supported by all applicable back-up documentation. The seller/vendor should be provided an additional discount DFI of, e.g., 0.05 percent on its purchases of some or all products if it makes payment via, e.g., automated clearing house (ACH) and provides remittance by electronic data interchange or another agreed upon cost effective methods (e.g., CTX or Excel).

Note that the seller/vendor may be provided an additional discount DFI of, e.g., 0.05 percent on its purchases of some or all products if it includes the following on all of its claiming submissions: A manufacturer credit memorandum number, and/or a valid manufacturer program reference number and timely backup documentation sufficient to support the claim submission. In the event that the seller/vendor fails to meet its obligations described in the additional two discounts of, e.g., 0.05 percent described above, the seller/vendor may not be eligible for these additional discounts until the, e.g., 2^{nd} month of the next quarter after it meets these obligations.

As far as returns are concerned, products sold to the seller/vendor are not returnable unless the manufacturer advises seller/vendor, in writing, that certain categories or specific models of products may be returned. In the event that the manufacturer has advised the seller/vendor that it has the right to return a category or specific models of products, the seller/vendor may return these products, e.g., in accordance with one of the following two return programs set forth below. The seller/vendor may advise the manufacturer in writing of the return program it selects for each category or models of products it is authorized to return.

Accordingly, one of the return programs includes that the seller/vendor agrees to not return any products it may be permitted to return. The manufacturer provides to the seller/vendor a category DFI on its purchases of all products that the seller/vendor is permitted to return as set forth in the manufacturer price sheets referenced herein. If the seller/vendor selects this option and nonetheless returns products to the manufacturer, such unauthorized returns may receive, e.g., 0 percent credit from the manufacturer and those products may not be returned to the seller/vendor.

A second return program includes that the seller/vendor desires to return a category or models of products it is permitted to return. The manufacturer may provide to the seller/vendor at the time of receipt a, e.g., 100 percent credit for any returned products that the seller/vendor is permitted to return equal to its last invoice price for such products. The manufacturer may test all returned products to determine if they are defective or not. A manufacturer may issue a monthly debit memo to the seller/vendor equal to, e.g., 50 percent of the last invoice price for any returned products it is permitted to return, if the manufacturer in its sole and final discretion determines no problem to be found (e.g., within the manufacturer's specifications and without cosmetic damage). The manufacturer may also reserve the right to charge the seller/vendor for any returned products not returned in its original manufacturer packaging with all supplied accessories and packaging materials. If desired, at no time may the manufacturer be obligated to return to the seller/vendor any non-defective products.

Note that with respect to certain products, only one or the other of the two return programs outlined above may be made available by the manufacturer to the seller/vendor. If the seller/vendor was authorized to return a category or models of products prior to agreeing to the terms and conditions set forth herein, and selects the first return program outlined above, the seller/vendor may have until a certain predetermined date to return any products it is permitted to return prior to the effective date of the terms and conditions outlined herein and agreed to by the manufacturer and seller/vendor. The seller/vendor should return products with an approved average true range (ATR) with the ATR number on the bill of lading (BOL). The seller/vendor may also be responsible to pay for freight on returns.

Furthermore, in consideration of the seller/vendor submitting on a weekly basis sell-in (order) forecast and sell through forecast for the following 26 weeks for all models, except for those otherwise noted, assorted by stock-keeping unit (SKU), the manufacturer may provide to the seller/vendor a discount DFI of, e.g., 0.5 percent on all products, unless otherwise noted, according to, e.g., the following exemplary model: (1) 20 percent of this discount DFI for submission of weekly sell-in (order) forecast data; or (2) 80 percent of this discount DFI for submission of weekly sell through forecast data; or (3) 100 percent of the discount DFI for submission of both (1) and (2) above. The weekly data for all models assorted by the seller/vendor should to be submitted by no later than, e.g., the close of business each Monday and in an electronic format compatible (e.g., minimum requirement being EDI 830 compliance) with a manufacturer's system, or any alternative format and template agreed to in writing by the parties.

Also if desired, the seller/vendor may agree to meet with the manufacturer no less than quarterly to review its collaborative business planning data in accordance with present principles. For purposes of determining whether the seller/vendor is complying with its obligations to provide sell-in and sell through forecast data herein, the seller/vendor may submit such data in the format required and by the required time for no less than, e.g., 11 weeks during each calendar quarter. In the event that the seller/vendor fails to meet its obligations for any given calendar quarter, it may not be eligible for this discount until, e.g., the 2nd month of the next quarter after it meets these obligations.

In consideration of the seller/vendor submitting on a weekly basis sell through and inventory data on models assorted by SKU, the manufacturer may provide to the seller/vendor a discount DFI of, e.g., 0.5 percent on all products (unless otherwise noted) according to the following exemplary model: (1) 25 percent of this discount DFI for submission of sell through and inventory data on a SKU basis; or (2) 50 percent of this discount DFI for compliance with (1) above and submission of total sell through and inventory data for each of its retail locations; or (3) 100 percent of this discount DFI for compliance with (1) and (2) above and submission of total sell through and inventory data for authorized retail channels reported separately from such data for each of its retail locations. The weekly data may be to be submitted by no later than, e.g., the close of business each Monday and be in an electronic format compatible (minimum requirement being EDI 852 compliance) with the manufacturer's systems or any alternative format agreed to in writing by the parties.

Even further, for purposes of determining whether the seller/vendor is complying with its obligations to provide sell through and inventory data, the seller/vendor may submit such data in the format required and by the required time for no less than, e.g., 11 weeks during each calendar quarter. In the event that the seller/vendor fails to meet its obligations for any given calendar quarter, it may not be eligible for this discount until, e.g., the 2^{nd} month of the next quarter after it meets the obligations.

Thus, the seller/vendor should understand that the manufacturer may use the sell through data to determine on a SKU basis if the predominate portion of the seller/vendor's sales are by its “brick and mortar” stores or by its authorized online retail channels. In the event that the seller/vendor does not provide the sell through data, the manufacturer may determine (using any information available) whether the seller/vendor's predominant sales are via its “brick and mortar” stores or authorized online retail channels.

If desired, in consideration of the seller/vendor and the manufacturer jointly agreeing on, e.g., a quarterly basis to the products (e.g., by category and SKU) that the seller/vendor may assort and purchase in quantities sufficient to meet expected consumer demand for the agreed upon minimum number of its retail locations and authorized online retail channels, the manufacturer may provide to the seller/vendor a category discount DFI on all products (unless otherwise noted) it purchases within that category as set forth in a manufacturer “Summary Discount Schedule,” as may be appreciated from the following exemplary model: (1) 25 percent of this discount for assorting the “silver” product range; or (2) 100 percent of this discount for assorting the “gold” product range.

Furthermore, the seller/vendor may be advised of the assortment of products that may allow it to earn the DFI applicable to “silver” and “gold” assortments. The initial agreed upon assortment(s) may be established, e.g., during the initial quarter of the calendar year and the seller/vendor may be entitled to this category discount DFI based on the agreed upon assortment(s). Thereafter, if the seller/vendor should fail to meet its obligations to assort in any given calendar quarter, this category discount may be adjusted to reflect the seller/vendor's actual assortment performance until, e.g., the 2^{nd} month of the next quarter after it meets its assortment obligations.

Further still, in consideration of the seller/vendor assorting, displaying and selling a lineup of agreed upon “premium” and “step-up” products, and purchasing such products in quantities sufficient to meet expected consumer demand, the manufacturer may provide to the seller/vendor a DFI as set forth in a manufacturer price sheet. Thus, these discounts may be provided for the following: (1) Model DFI provided to the seller/vendor if selling the agreed upon products predominantly through its “brick and mortar” stores and who display those products via a live display with live demonstrators; (2) Model DFI provided to the seller/vendor for the consumer benefits (e.g., from a list of consumer benefits set forth on a manufacturer production possibility frontier (PPF) Chart) that are chosen to be performed, and which a manufacturer believes are required to educate consumers to allow consumers to make an informed decision to purchase the manufacturer's premium products. The PPF chart referenced above may include the following: (1) a “significant presence” section requiring a minimum of, e.g., 20 percent of the seller/vendor's stores being dedicated to consumer electronics; (2) a “dedicated category” section requiring, e.g., the seller/vendor to focus on consumer-electronics-sophisticated consumers and premium products in product category segments as opposed the overall consumer electronic general products; (3) an “assisted force” section requiring, e.g., that the seller/vendor has at least one sales associate who is to manage only a consumer electronics area of the seller/vendor's store; (4) a “trained sales force” section requiring that the seller/vendor have sales associates who are trained, e.g., by the manufacturer or a third party education course either in person or using a computer; (5) a “commissioned sales force” section requiring that the seller/vendor compensate its sales associates based on their knowledge of the seller/vendor's products and the associates' respective selling skills/abilities; and/or (5) a “free premium space placement” section requiring that the vendor/seller agree to provide strategic space within the seller's store where products have a higher likelihood of being viewed and vended without additional charge.

Thus, the seller/vendor may be advised of the PPF products that may allow it to earn the product discount DFI. Thereafter, if the seller/vendor fails to meet its obligations in any given calendar quarter, this category discount may be adjusted to reflect the seller/vendor's actual performance until the 2^{nd} month of the next quarter after it meets the obligations.

Moreover, in consideration of the seller/vendor complying with the terms of any applicable minimum advertised price (MAP) program, the manufacturer may provide to the seller/vendor the MAP allowance DFI for all MAP products it purchases as set forth in any applicable MAP program.

In addition, the seller/vendor may earn advertising funds for each category of products it purchases from the manufacturer for use by the seller/vendor to support its category specific qualified advertisements (as outlined below) agreed in advance in writing with the manufacturer. The category specific fund may be calculated as, e.g., 0.5 percent of purchases (net of returns) by the seller/vendor from the manufacturer of each category of products (unless otherwise noted) during a specified fiscal year. The seller/vendor may draw against the category fund on a dollar for dollar match, up to 50 percent of total cost, based upon, for example, proof of placement of a qualifying advertisement as outlined below:

(1) Direct Mail—Request for payment requires Original, Copy, or PDF of mailing, as well as a Description of mailing list (i.e. credit card holders);

(2) Email—Request for payment requires copy of Email. Date, approximate number recipients, demographic information or description of recipients (i.e. credit card customers, web subscribers);

(3) Media Placement/Billboard Advertisement—Request for payment requires picture of billboard or design/artwork accompanied by an invoice from the vendor to the seller/vendor. Picture of vehicle is required if it is a moving billboard. Location of billboard for stationary billboard only. Product category claimed may be shown or mentioned in the billboard;

(4) Media Placement—Print—Request for payment requires original tear sheet, or PDF date of advertising may be documented either on the page that the product is shown or on the front or back cover of the magazine, sports program, entertainment program, yearbook, etc. If a date is unavailable, then a documented notice from the manufacturer or the seller/vendor is required. If the seller/vendor's name is not on the page that includes the ad, then the front cover of the POP is required;

(5) Media Placement—Radio—Request for payment requires: AN tape or electronic file or typed copy of script. Sample page of dates and run times. Original or copy of notarized affidavit is required on at least one page. This page can be the invoice, statement, script, or general affidavit, as long as the page can be linked to the Seller/vendor and Products advertised;

(6) Media Placement on TV—Request for payment requires AN tape or electronic file or typed copy of script. Sample page of dates and run times. Original or copy of notarized affidavit is required on at least one page. This page can be the invoice, statement, script, or general affidavit, as long as the page can be linked to the seller/vendor and products advertised;

(7) Media Placement—Web—Request for payment requires: dated screen print. If the ad date is not available on the screen print, then ad date information may be provided by the seller/vendor or the manufacturer's sales representative. For the seller/vendor's website videos: DVD of video or electronic file and date the video ran on the website; and/or

(8) Funds have been earned based on net purchases from the manufacturer.

Note that the seller/vendor may have until a specified date to place advertisements against any specific category specific reserve account available to it and has until, e.g., a month later to verify that it placed a qualifying advertisement. Any amount in any category specific reserve account not claimed by the Seller/vendor by date one month later may be forfeited.

As permitted by the terms and conditions of an agreement between the seller/vendor and the manufacturer, the seller/vendor may acknowledge that its failure to reimburse the manufacturer for any funds it has incorrectly paid the manufacturer reserves its right to recoup any discount paid, and may mean that it no longer can participate in this discount and forfeits any category specific funds available to it.

In exemplary embodiments, qualified advertisements may:

(1) Mention the manufacturer within the qualified advertisement (there may be no requirement that the manufacturer be the exclusive brand advertised);

(2) Highlight no less than, e.g., 3 specific features of the advertised product;

(3) Comply with the terms of any MAP or SURE programs applicable to the Products (If the product not part of any MAP or supplemental revenue assistance payments (SURE) program, then any advertised price may be at or above pre-determined specifications; and/or

(4) Not funded via any other offer from the manufacturer.

Additionally, in consideration of the seller/vendor agreeing each quarter in writing with the manufacturer on its execution of merchandising and promotional activities at its retail locations and online authorized retail channels that enhance the manufacturer's brand and increase sales of products (e.g., via a Visibility Plan), the manufacturer may provide to the seller/vendor a discount trailing credit (TC) on its purchase of products (unless otherwise noted) on a quarterly basis as set forth in a manufacturer Summary Discount Schedule, e.g., for the following:

(1) Display correctly executed and properly functioning activities and displays, including shelf merchandising and promotional displays;

(2) Provide to the manufacturer the agreed upon positioning on the seller/vendor's shelves and for displays of products (e.g., follow agreed upon plan-o-gram);

(3) Utilize mutually agreed upon manufacturer assets (e.g., POP Material); and/or

(4) Displays include key features (e.g., fact tags, price, model number, telling the manufacturer's designated story, etc.).

Note that the manufacturer may monitor, either directly or indirectly, the seller/vendor's performance against a Visibility Plan to determine the seller/vendor's performance using, e.g., a computer and/or tool such as the tool described above. For a seller/vendor who is authorized for sales of products via their retail locations and online authorized retail channels, compliance may be weighed, e.g., 75 percent retail locations and 25 percent authorized online retail channels. Based on its monitoring, the seller/vendor may earn payment of an agreed upon discount, which may be appreciated from the following exemplary outline:

(1) Compliance between 85 percent to 100 percent - 100 percent of the discount TC;

(2) Compliance between 50.1 percent to 84.9 percent - 50 percent of the discount TC;

(3) Compliance 50 percent or less-0 percent of the discount TC.

Note that in the event that the seller/vendor fails to meet its obligations for any given calendar quarter, it may not be eligible for this discount, e.g., until the 2^{nd} month of the quarter after it meets these obligations. A manufacturer may compute and notify the seller/vendor of the amount earned (based on, e.g., purchases, net of returns, etc.) and credited to the seller/vendor within, e.g., 30 days of the end of each quarter.

In consideration of the seller/vendor agreeing each quarter in writing with the manufacturer on its execution of activities that allow its sales staff and its online authorized retail channels to actively promote and endorse products, the manufacturer may provide to the seller/vendor a discount TC on its purchase of products (unless otherwise specified) on a quarterly basis as set forth in a manufacturer Summary Discount Schedule, which may include the following exemplary items:

(1) Actively promotes and endorses products; and/or

(2) Clearly articulates and demonstrates features on Products that provide benefits to consumers.

Note that the manufacturer may monitor the seller/vendor's performance via use of, e.g., a mystery shopper program, either directly or indirectly, to determine the seller/vendor's performance. For a seller/vendor who is authorized for sales of products via their retailer locations and online authorized retail channels, compliance may be weighed, e.g., 75 percent retail locations and 25 percent online retail channels. Based on its monitoring, the seller/vendor may earn the following exemplary payment of the agreed upon discount:

(1) Compliance between 85 percent to 100 percent—100 percent of the discount TC;

(2) Compliance between 50.1 percent to 84.9 percent—50 percent of the discount TC;

(3) Compliance 50 percent or less—0 percent of the discount TC.

In the event that seller/vendor fails to meet its obligations for any given calendar quarter, it the seller/vendor may not be eligible for this discount until, e.g., the 2^{nd} month of the quarter after it meets these obligations. A manufacturer may compute and notify the seller/vendor of the amount earned (based on, e.g., purchases, net of returns, etc.) and credited to the seller/vendor within, e.g., 30 days of the end of each quarter.

Moving on, note that the following exemplary Terms and Conditions may apply to all or part of the manufacturer program set forth above:

(1) General: The manufacturer reserves the right to cancel or modify the manufacturer program at any time and for any reason.

(2) Program Variances: The manufacturer in its sole discretion reserves the right to refuse to provide any trailing credits or allowances to the seller/vendor if any of the manufacturer program requirements are not followed. To the extent that any credits or allowances are provided and deducted from invoices (DFI), the manufacturer may in its sole discretion demand repayment from the seller/vendor, to be repaid within thirty (30) days from the date of the manufacturer's demand for repayment. The manufacturer DFI and TC discounts may be evaluated by the manufacturer on a quarterly basis. The manufacturer may notify the seller/vendor of any changes in the next quarter's discount percent prior to the changes taking effect. The seller/vendor is responsible to update its new and open purchase orders to reflect the new pricing as a result of changes in the manufacturer discounts. In the event that there is a difference between the customer's purchase order (PO) price and the manufacturer's invoice price solely due to timing in changing customer's purchase order prices, the manufacturer's invoice price may take precedence and may be paid in full within agreed upon terms.

(3) Claim Contents: The manufacturer may receive all claims within thirty (30) days of the end of the manufacturer program period. Claims may contain the following data:

(a) A manufacturer program reference number;

(b) A manufacturer model name;

(c) Claim quantity;

(d) Claim dollar amount; and

(e) Applicable back-up documentation.

(4) Credits, Discounts & Rebates: Credits, discounts, rewards, and rebates issued to the seller/vendor by the manufacturer herein or any program announced in connection herewith by the manufacturer are available for use by the seller/vendor only for the future purchase of the products from the manufacturer. They are not cash equivalents, do not create a right of payment to the seller/vendor, and in any event are not deemed earned until the seller/vendor has paid the manufacturer in full for the products and, where applicable, bundled products. Any such credits, discounts, rewards and rebates are subject to all of the manufacturer's rights under applicable state or federal law, including, but not limited to, its rights of set of setoff and recoupment.

If the seller/vendor is the subject of a voluntary or involuntary bankruptcy proceeding, automatic stay may not be applicable to any attempt by the manufacturer to effect a reconciliation of accounts with the seller/vendor against amounts due the manufacturer.

If any merchandise or amounts previously paid by the seller/vendor to the manufacturer are returned, forfeited, or subject to avoidance or similar action in a bankruptcy proceeding or a proceeding under any similar state statute or federal law, such credits, discounts, rewards and rebates may be deemed null and void and not earned, and any credits, discounts and rebates previously issued to the seller/vendor that, for whatever reason, are not deemed null and void, may be used to offset any amounts due the manufacturer.

(5) Advertising: If advertising is required under a the manufacturer program, or if the seller/vendor chooses to promote an instant rebate in connection with a program, the following terms and conditions apply:

(A) Advertising Approval Process: Where required under the manufacturer program's terms, a seller/vendor may submit to the manufacturer, for review and collaboration, their advertising vehicle plans, including advertising dates and supported SKU's, not less than fourteen days prior to ad placement. If the seller/vendor's primary advertising vehicle is the Internet, certain programs may require that the seller/vendor receive prior written approval from the manufacturer's sales representative.

(B) Advertising/Layout Requirements:

(i) Regardless of whether prior written approval is required, advertising may include both the product and the advertised price and be displayed prior to checkout (strikethroughs do not qualify).

(ii) The seller/vendor may use its primary advertising vehicle(s) (i.e., in-store advertising, Email “blasts,” magazine ads, flyers and catalogs, Sunday inserts, newsprint, radio and broadcast ads) to advertise products.

(iii) If the seller/vendor advertises on their website, the seller/vendor may advertise the offer on all web pages relating to the products during the entire applicable period in a manner at least as prominent as the most prominent third party advertisement for product sold on the seller/vendor's website at the same time.

(iv) If a program requires that a particular price be advertised, the seller/vendor may not use any of the following types of references to make a different price visible to internet customers:

“Click here for lower price”

“See Price In Cart”

“Add To Cart For Lower Price”

“Check Cart For Lower Price”

“Mouse over for Price”

Strikethroughs where the required advertised price is not shown as the final advertised price may also not qualify under the program. This restriction on advertised price does not apply to the “Final Checkout Stage,” which is understood to be the section of the website that consumers use to pay for a product by their providing personal information or login, not accessible by price comparison search engines or spiders and which is encrypted for security purposes to limit fraud.

(v) During the Program Period, Seller/vendor may not condition its advertised price on the purchase of any additional item.

(vi) The seller/vendor may execute its advertising in the following format in order to collect the trailing credits being offered in this Program:

(a) Product may be quoted as “after instant discount.” For example, a product that might normally sell in the seller/vendor's storefront for $399.99 may be presented/promoted as “Normally $399.99, This Week! $349.99 after instant savings or something similar. The manufacturer's Representative reviewing the advertising may have final determination as to whether the advertisement complies with applicable guidelines.

(b) The seller/vendor may not use the word “only” when referencing dates and discounts in conjunction with the execution of this program. Advertising including terms such as “This Week Only” or “Only This Week” when referencing the product pricing may not be eligible for credits under this program.

(6) Seller/vendor Funded Value Add Offers: If a program permits the seller/vendor to fund additional “Value Add Offers”, qualifying products may be included in the Value Add Offer if it is a Global Offer. “Global Offer” is understood to mean an offer applicable to all brands of a type of product advertised and/or sold by the participating Eligible Retailer during the Program Period (i.e., Free Shipping on all Digital Still Cameras), as opposed to an offer specific to a particular brand of that type of product (i.e., Free Shipping on A manufacturer Digital Still Cameras).

For purposes of this program, the following are not considered Global Offers, and the seller/vendor may not be eligible to receive any trailing credit amounts under the program if any qualifying product is promoted in connection with the following types of offers during the program period:

(i) All On Sale Promotions (e.g., “10 percent off all Digital Still Cameras” or “$100 off all Digital Still Cameras”).

(ii) Gift Card Promotions with Digital Still Camera purchase (unless the gift card may be redeemed only at a future time, in which case the gift card promotion may be permitted).

(iii) Store-wide Instant Rebate or Coupon offers with Digital Still Camera purchase.

If a program does not permit the seller/vendor-funded value add offers, qualifying products may be excluded from any “Global Offer” being advertised by the seller/vendor during the applicable program periods, except that free financing offers from the seller/vendor on entire product categories (for instance, “12 months same as cash on all Camcorders”) is allowed.

(7) Audit: For the purpose of verifying compliance by the seller/vendor with the provisions of and obligations contemplated by any program in which the seller/vendor claims participation, the seller/vendor may, upon request, provide the manufacturer and its representatives with sufficient documentation relating to the seller/vendor's claim. The seller/vendor may allow the manufacturer to audit such documentation at reasonable intervals and permit the manufacturer to make copies or abstracts therefrom.

With the foregoing Terms and Conditions in mind, programs in accordance with present principles that are carried out in conjunction with the computerized tracking tool are described further below. Note that the manufacturer's “total investment” is understood to be the difference between SPPG and Net-Net Dealer Price. In certain embodiments, there may be nine price discounts and two allowances in accordance with present principles. Note that sellers/vendors are free to independently determine whether they wish to earn the maximum benefit offered under the program(s) set forth herein. Sellers/vendors are also free to independently determine their resale prices and terms on the manufacturer's products and whether they wish to participate in the manufacturer's MAP and SURE programs.

While the particular BEHAVIOR-BASED PRICING PARADIGM is herein shown and described in detail, it is to be understood that the subject matter which is encompassed by the present invention is limited only by the claims.

What is claimed is:

1. Computer comprising:
processor;
computer readable storage medium accessible to the processor and bearing instructions executable by the processor to cause the processor to:
determine whether to apply a basic discount to an account of a seller of products based at least in part on determining whether the seller has adhered to a seller agreement;
determine whether to apply an efficiency discount to the account of the seller based at least in part on determining whether at least one efficiency metric has been satisfied by the seller, wherein the efficiency discount is established by one or more of: a payment efficiency discount with an efficiency metric of payment with a predetermined time period and/or payment by a predetermined payment mode, and a return efficiency discount with an efficiency metric of adherence to a manufacturer's return policy;
determine whether to apply a strategy discount to the account of the seller based at least in part on whether at least one strategy metric has been satisfied by the seller, wherein the strategy discount is established by one or more of: a collaborative planning discount with a strategy metric of providing at least one sales forecast, a point of sale (POS) sell-out discount with a strategy metric of compliant sales, an assortment strategy discount with a strategy metric of achieving a predetermined product assortment, a premium product strategy discount with a strategy metric of sales of premium products, and an allowance strategy discount with a strategy metric of complying with at least one advertising standard for a predetermined product;
determine whether to apply an execution discount to the account of the seller based at least in part on whether at least one execution metric has been satisfied by the seller, wherein the execution discount is established by one or more of: a consumer visibility execution discount with an execution metric of adhering to a predetermined product merchandising and display plan, a consumer conversion execution discount with an execution metric of shopper questionnaire approval, and an advertising fund execution discount with an execution metric of advertising by the seller.

2. The computer of claim 1, wherein the efficiency discount is established by the payment efficiency discount with the efficiency metric of payment with a predetermined time period.

3. The computer of claim 1, wherein the efficiency discount is established by the payment efficiency discount with the efficiency metric of payment with and/or payment by a predetermined payment mode.

4. The computer of claim 1, wherein the efficiency discount is established by the return efficiency discount with the efficiency metric of adherence to a manufacturer's return policy.

5. The computer of claim 1, wherein the strategy discount is established by the collaborative planning discount with the strategy metric of providing at least one sales forecast.

6. The computer of claim 1, wherein the strategy discount is established by the point of sale (POS) sell-out discount with the strategy metric of compliant sales.

7. The computer of claim 1, wherein the strategy discount is established by the assortment strategy discount with the strategy metric of achieving a predetermined product assortment.

8. The computer of claim 1, wherein the strategy discount is established by the premium product strategy discount with the strategy metric of sales of premium products.

9. The computer of claim 1, wherein the strategy discount is established by the allowance strategy discount with the strategy metric of complying with at least one advertising standard for a predetermined product.

10. The computer of claim 1, wherein the execution discount is established by the consumer visibility execution discount with the execution metric of adhering to a predetermined product merchandising and display plan.

11. The computer of claim 1, wherein the execution discount is established by the consumer conversion execution discount with the execution metric of shopper questionnaire approval.

12. The computer of claim 1, wherein the execution discount is established by the advertising fund execution discount with the execution metric of advertising by the seller.

13. Computer comprising:
processor;
computer readable storage medium accessible to the processor and bearing instructions executable by the processor to cause the processor to:
store seller discounts that are based on desired seller behavior;
receive information relating to seller behavior; and
use the information to ascertain whether predetermined discount metrics have been satisfied.

14. The computer of claim 13, wherein the processor, based at least in part on the outcome of ascertaining whether predetermined discount metrics have been satisfied, determines whether to provide one or more discounts to a seller.

15. The computer of claim 13, wherein the processor determines whether to provide a basic discount to the seller based at least in part on determining whether the seller has adhered to a seller agreement.

16. The computer of claim 13, wherein the processor:
determines whether to provide an efficiency discount to the seller based at least in part on determining whether at least one efficiency metric has been satisfied by the seller, wherein the efficiency discount is established by one or more of: a payment efficiency discount with an efficiency metric of payment with a predetermined time period and/or payment by a predetermined payment mode, and a return efficiency discount with an efficiency metric of adherence to a manufacturer's return policy;
determines whether to provide a strategy discount to the seller based at least in part on whether at least one strategy metric has been satisfied by the seller, wherein the strategy discount is established by one or more of: a collaborative planning discount with a strategy metric of providing at least one sales forecast, a point of sale (POS) sell-out discount with a strategy metric of compliant sales, an assortment strategy discount with a strategy metric of achieving a predetermined product assortment, a premium product strategy discount with a strategy metric of sales of premium products, and an allowance strategy discount with a strategy metric of complying with at least one advertising standard for a predetermined product; and/or
determines whether to provide an execution discount to the seller based at least in part on whether at least one execution metric has been satisfied by the seller, wherein the execution discount is established by one or more of: a consumer visibility execution discount with an execution metric of adhering to a predetermined product merchandising and display plan, a consumer conversion execution discount with an execution metric of shopper questionnaire approval, and an advertising fund execution discount with an execution metric of advertising by the seller.

17. Computer comprising:
processor;
computer readable storage medium accessible to the processor and bearing instructions executable by the processor to cause the processor to:
determine whether to apply a basic discount to an account of a seller of products based at least in part on determining whether the seller has adhered to a seller agreement.

18. The computer of claim 17, wherein the processor is further caused to determine whether to apply an efficiency discount to the account of the seller based at least in part on determining whether at least one efficiency metric has been satisfied by the seller, wherein the efficiency discount is established by one or more of: a payment efficiency discount with an efficiency metric of payment with a predetermined time period and/or payment by a predetermined payment mode, and a return efficiency discount with an efficiency metric of adherence to a manufacturer's return policy.

19. The computer of claim 17, wherein the processor is further caused to determine whether to apply a strategy discount to the account of the seller based at least in part on whether at least one strategy metric has been satisfied by the seller, wherein the strategy discount is established by one or more of: a collaborative planning discount with a strategy metric of providing at least one sales forecast, a point of sale (POS) sell-out discount with a strategy metric of compliant sales, an assortment strategy discount with a strategy metric of achieving a predetermined product assortment, a premium product strategy discount with a strategy metric of sales of premium products, and an allowance strategy discount with a strategy metric of complying with at least one advertising standard for a predetermined product.

20. The computer of claim 17, wherein the processor is further caused to determine whether to apply an execution discount to the account of the seller based at least in part on whether at least one execution metric has been satisfied by the seller, wherein the execution discount is established by one or more of: a consumer visibility execution discount with an execution metric of adhering to a predetermined product merchandising and display plan, a consumer conversion execution discount with an execution metric of shopper questionnaire approval, and an advertising fund execution discount with an execution metric of advertising by the seller.
